(19) United States
(12) Patent Application Publication
(10) Pub. No.: US 2026/0133701 A1
(43) Pub. Date: May 14, 2026

(54) SEGMENTED DATA LINES IN MEMORY SYSTEMS

(71) Applicant: Micron Technology, Inc., Boise, ID (US)

(72) Inventors: Simon J. Lovett, Nampa, ID (US); Brent Keeth, Boise, ID (US); James Brian Johnson, Boise, ID (US)

(21) Appl. No.: 19/373,377

(22) Filed: Oct. 29, 2025

Related U.S. Application Data
(60) Provisional application No. 63/718,486, filed on Nov. 8, 2024.

(51) Int. Cl. G06F 3/06

(52) U.S. Cl. CPC G06F 3/0622; G06F 3/0659; G06F 3/0673

(57) ABSTRACT

Methods, systems, and devices for segmented data lines in memory systems are described. A memory system may include multiple first banks and multiple second banks with logic circuitry coupled with the multiple first and second banks. In such examples, the logic circuitry may be configured to facilitate communication with the multiple first and second banks and be positioned between the multiple first and second banks. The memory system may further include a first segment of a data line coupled with a first set of the multiple first banks and coupled with the logic circuitry and include a second segment of the data line coupled with a second set of multiple first banks. Additionally, the memory system may include repeater circuitry coupled with the first segment and the second segment and positioned between the first set of the multiple first banks and the second set of the multiple first banks.

### CROSS REFERENCE

The present Application for Patent claims priority to U.S. patent application Ser. No. 63/718,486 by Lovett et al., entitled “SEGMENTED DATA LINES IN MEMORY SYSTEMS,” filed Nov. 8, 2024, which is assigned to the assignee hereof, and which is expressly incorporated by reference in its entirety herein.

### TECHNICAL FIELD

The following relates to one or more systems for memory, including segmented data lines in memory systems.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports segmented data lines in memory systems in accordance with examples as disclosed herein.

FIG. 2A shows an example of a system that supports segmented data lines in memory systems in accordance with examples as disclosed herein.

FIG. 2B shows an example of a system that supports segmented data lines in memory systems in accordance with examples as disclosed herein.

FIG. 2C shows an example of a system that supports segmented data lines in memory systems in accordance with examples as disclosed herein.

FIG. 3 shows a block diagram of a memory system that supports segmented data lines in memory systems in accordance with examples as disclosed herein.

FIGS. 4 and 5 show flowcharts illustrating a method or methods that support segmented data lines in memory systems in accordance with examples as disclosed herein.

### DETAILED DESCRIPTION

A memory system may be designed to satisfy (e.g., meet) a target bandwidth, where the target bandwidth may be affected by a bank cycle time of the memory system. A bank cycle time, also be referred as column-to-column delay time (tCCD), may be a threshold time interval (or quantity of clock cycles) between two successive access commands at a column. In such examples, the bank cycle time of the memory system may be limited by a capacitance of data lines coupled with banks of the memory system, where the capacitance (e.g., resistance and capacitance (RC) time constant) of data lines of the memory system may be based on a length of the data lines. For example, as the length of the data line increases, the capacitance of the data line may increase, leading to longer bank cycle times. Such longer bank cycle times, however, may reduce the bandwidth of the memory system, leading increased latency and reduced performance. Thus, techniques may be desired to reduce the bank cycle time of the memory system.

The techniques, methods, and devices described herein may enable a memory system to support segmented data lines, such that a length of each data line may be less than a threshold distance, leading to shorter bank cycle times in the memory system. To support such segmented data lines, the memory system may implement one or more repeater circuits to couple the segmented data lines with logic circuitry and to also facilitate access commands to different banks of the memory system. For example, a memory system may include logic circuitry positioned between a first set of banks and a second set of banks, where the logic circuitry may facilitate the communication between the first set of banks and the second set of banks. The memory system may include a first segment of a data line that is coupled with a first subset of the first set of banks and a second segment of the data line that is coupled with a second subset of the first set of banks. In such examples, the first and second segments of the data lines may be coupled with relatively fewer banks than other memory systems, leading to the lengths of the first and second segments to be shorter than such other memory systems. By implementing such segmented data lines, the memory system may experience reduced bank cycle times and increased bandwidth, thereby improving performance within the memory system.

In addition to applicability in memory systems as described herein, techniques for segmented data lines in memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by segmenting data lines coupled with banks of memory within the memory system, which may decrease processing or latency times, improve response times, or otherwise improve user experience, among other benefits.

Features of the disclosure are illustrated and described in the context of systems and architectures. Features of the disclosure are further illustrated and described in the context of systems and flowcharts.

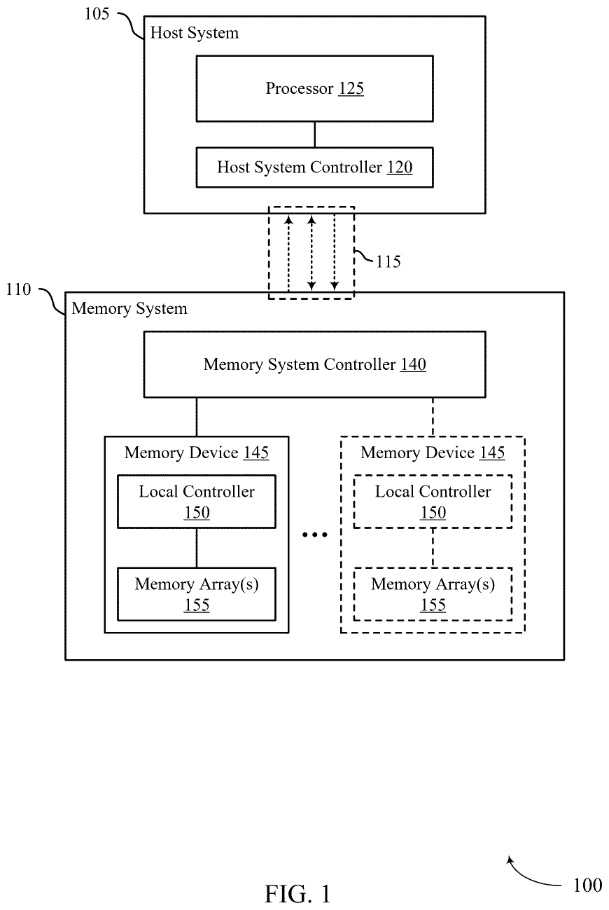

FIG. 1 illustrates an example of a system 100 that supports segmented data lines in memory systems in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, TCDRAM cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

The memory system 110 may be designed to satisfy (e.g., meet) a target bandwidth, where the target bandwidth may be affected by a bank cycle time of the memory system 110. A bank cycle time may be a threshold time interval (or quantity of clock cycles) between two successive access commands at a column. In such examples, the bank cycle time of the memory system 110 may be limited by a capacitance of data lines coupled with banks of the memory system 110, where the capacitance of data lines of the memory system 110 may be based on a length of the data lines. For example, as the length of the data line increases, the capacitance of the data line may increase, leading to longer bank cycle times. Such longer bank cycle times, however, may reduce the bandwidth of the memory system 110, leading increased latency and reduced performance. Thus, techniques may be desired to reduce the bank cycle time of the memory system 110.

The techniques, methods, and devices described herein may enable a memory system 110 to support segmented data lines, such that a length of each data line may be less than a threshold distance, leading to shorter bank cycle times in the memory system 110. To support such segmented data lines, the memory system 110 may implement one or more repeater circuitries to couple the segmented data lines and to also facilitate access commands to different banks of the memory system 110. For example, a memory system 110 may include logic circuitry positioned between a first set of banks and a second set of banks, where the logic circuitry may facilitate the communication between the first and second sets of banks. The memory system 110 may include a first segment of a data line that is coupled with a first subset of the first set of banks and a second segment of the data line that is coupled with a second subset of the first set of banks. In such examples, the first and second segments of the data lines may be coupled with relatively fewer banks than other memory systems 110, leading to the lengths of the first and second segments of the data line to be shorter than data lines of the other memory systems 110. By implementing such segmented data lines, the memory system 110 may experience reduced bank cycle times and increased bandwidth, thereby improving performance within the memory system 110.

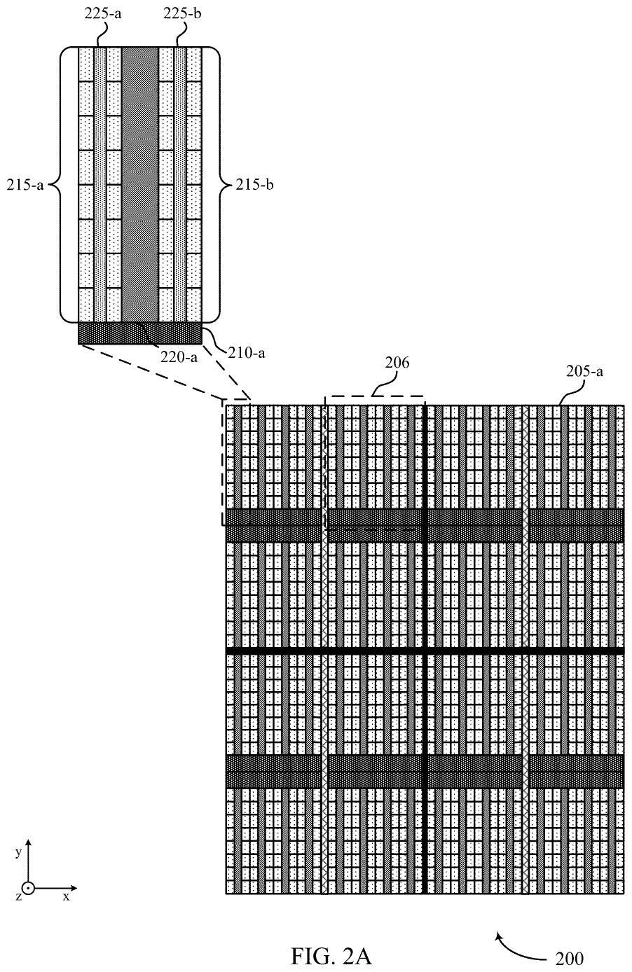

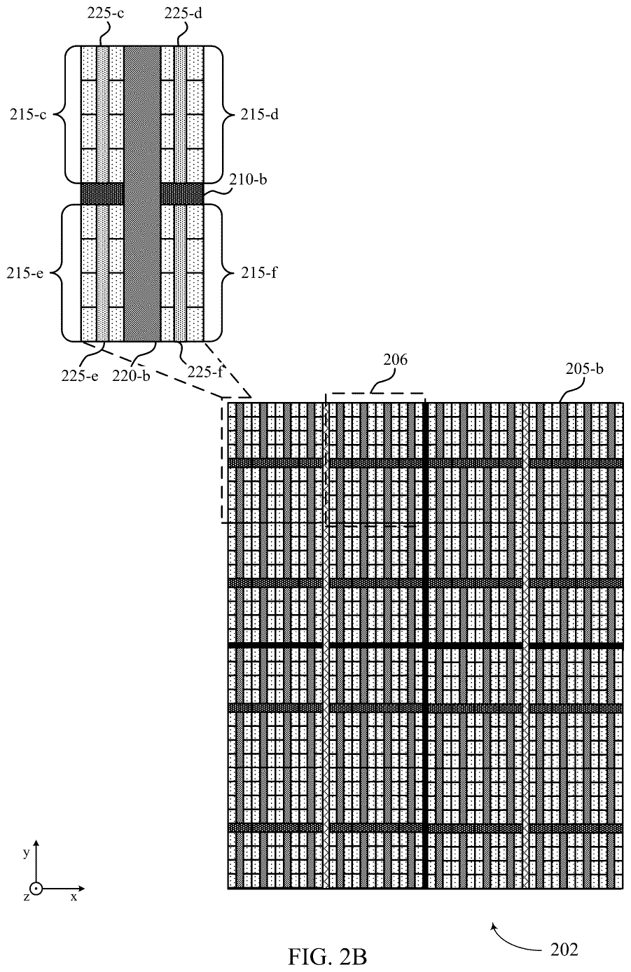

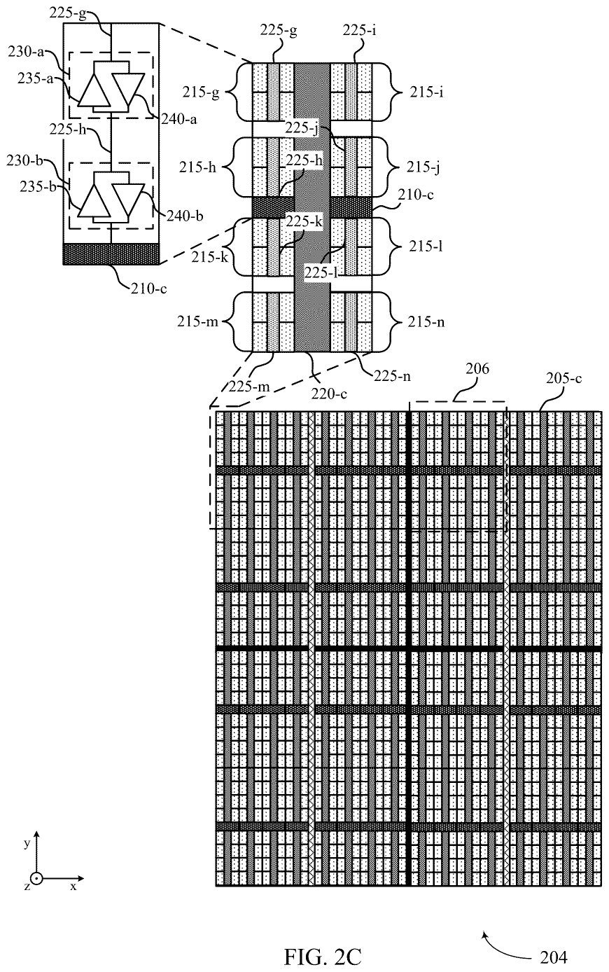

FIGS. 2A, 2B, and 2C show examples of a system 200, as system 202, and a system 204 that support segmented data lines in memory systems in accordance with examples as disclosed herein. Aspects of the systems 200, 202, and 204 may implement, or be implemented by, aspects of the system 100. For example, the systems 200, 202, and 204 may include dies 205 (e.g., a die 205-a, a die 205-b, and a die 205-c), which may be examples of memory devices 145 within a memory system 110 as described herein with reference to FIG. 1. Each of the dies 205 may be illustrated in a top-down view (e.g., viewed looking at a top of the die in the z direction). The techniques described in the context of the systems 200, 202, and 204 may enable a memory system 110 to support segmented data lines 225, leading to reduced banks cycle times in the memory system 110.

With respect to the system 200, the die 205-a may include multiple sections 206 (e.g., 16 sections 206), where each section 206 may include logic circuitry 210 coupled with multiple sets of banks 215 (e.g., eight sets of banks 215) via respective data lines 225 (e.g., global input/output (GIO) lines). As illustrated, each of the banks 215 of a section 206 may be positioned above (in the y direction) the logic circuitry 210 or below (in the y direction) the logic circuitry 210. Additionally, each section 206 may include multiple bank logic circuitries 220 each coupled with two respective sets of banks 215. As described herein, the logic circuitry 210 may be a through silicon via (TSV) that includes column select circuitry, column decoder circuitry, I/O circuitry, or any combination thereof.

As an illustrative example, the logic circuitry 210-a may be coupled with banks 215-a (e.g., multiple banks or a set of banks) via a data line 225-a (e.g., a GIO line) and be coupled with banks 215-b via a data line 225-b (e.g., a GIO line). In such examples, the data lines 225 of the die 205-b may be referred to as full length data lines (e.g., full length GIO lines) based on the length of the data lines 225, a quantity of banks 215 coupled with the data lines 225, or both.

The memory system is designed to get data in and out of banks 215-a and 215-b via data path circuitry. Each bank 215 may include bit lines and sensing circuitry (e.g., sense amplifiers). In the context of a read operation, the sense circuitry of the bank may receive a signal from a bit line and output information to a local I/O, which may include additional amplifiers and/or sensing circuitry to communicate the information. The local I/O may be coupled with a GIO, which may include additional amplifiers and/or sensing circuitry to communicate the information. Finally, the GIO may deliver the information to the logic circuitry 210 to be communicated other components and/or devices. Additionally, the banks 215-a and 215-b, and the logic circuitry 210-a may be coupled with bank logic circuitry 220-a, which may be configured to facilitate access to one or more banks 215.

Accordingly, to read from one of the banks 215 in the banks 215-a, the logic circuitry 210-a may activate the data line 225-a to receive the data from the identified bank 215. Similarly, to write to one of the banks 215 of the banks 215-a, the logic circuitry 210-a may activate the data line 225-a to communicate the data from the logic circuitry 210-a to with the identified bank 215. In this way, the logic circuitry 210-a may communicate data to and from the banks 215 via the respective data lines 225.

In some cases, the memory system 110 implementing the die 205-a may have a target bandwidth (e.g., 20 GB/s), which may lead to the die 205-a having a bank cycle time less than a threshold time (e.g., tCCD<=1.6 nanoseconds). A bank cycle time may be a threshold time interval (or quantity of clock cycles) between two successive access commands at a bank 215 of the die 205-a. In such examples, the bank cycle time of the die 205-a may be limited based on a capacitance of the data lines 225 coupled with the banks 215. For example, the capacitance (e.g., RC time constant) of the data lines 225 may be based on a length of the data lines 225, where, as the length of the data line 225 increases, the capacitance of the data line 225 may also increase. As the capacitance increases, it may take more time to change the voltage on the data line, thereby increasing bank cycle times. In such cases, however, increased capacitances in the data lines 225 may lead to relatively longer bank cycle times. Such longer bank cycle times may reduce the bandwidth of the memory system 110, leading increased latency and reduced performance. Thus, techniques may be desired to reduce the bank cycle time of the memory system 110

In accordance with the techniques described herein, the memory system 110 may implement dies 205, such as the die 205-b and the die 205-c, that support segmented data lines 225. By implementing such segmented data lines 225, the length of each data line 225 may decrease, thereby decreasing the capacitance of each of the data lines 225. Accordingly, as the capacitance of the data lines 225 decreases, the die 205-c may decrease the bank cycle times associated with accessing the banks 215, thereby enabling the memory system 110 to obtain the target bandwidth.

With respect to the system 202, the die 205-b may include multiple sections 206 each including logic circuitry 210 coupled with multiple banks 215 via respective data lines 225. As illustrated, each section 206 may include logic circuitry 210 having a first set of banks 215 (e.g., banks 215-c and 25-d) positioned above (in the y direction) the logic circuitry 210 and a second set of banks 215 (e.g., banks 215-e and 215-f) positioned below (in the y direction) the logic circuitry 210.

As an illustrative example, the logic circuitry 210-b may be coupled with the banks 215-c and 215-d via the data lines 225-c and 225-d, respectively, while also being coupled with the banks 215-e and 215-f via the data lines 225-e and 225-f, respectively. In such examples, the banks 215-c and 215-d may be positioned above (in the y direction) the logic circuitry 210-b and the banks 215-e and 215-f may be positioned below (in the y direction) the logic circuitry 210-b. Additionally, each of the banks 215 may be coupled with the same bank logic circuitry 220-b. As described herein, the banks 215 may be coupled with the respective data lines 225 via data path circuitry (e.g., sensing circuitry, bit lines, local I/Os, among other examples).

Accordingly, to read from one of the banks 215 in the banks 215-c, the logic circuitry 210-b may activate the data line 225-c to receive the data from the data path circuitry of the identified bank 215. Similarly, to write to one of the banks 215 of the banks 215-c, the logic circuitry 210-b may activate the data line 225-c to communicate the data from the logic circuitry 210-b to the data path circuitry associated with the identified bank 215. In this way, the logic circuitry 210-b may communicate data to and from the banks 215 via the respective data lines 225.

By implementing the logic circuitry 210-b between the first and second set of banks 215, the memory array may reduce the length of the data lines 225, thereby reducing the bank cycle time of the memory system 110 relative to the bank cycle time of the die 205-a. In such examples, the data lines 225 of the die 205-b may be referred to as half-length data lines 225 relative to those of the die 205-a (e.g., the data lines 225 of the die 205-b are half the length of the data lines 225 of the die 205-a). The logic circuitry 210 may include one or more through silicon vias (TSVs) and/or other supporting circuitry. Thus, distributing additional logic circuitry 210 throughout a memory system may reduce the quantity of memory cells configured to store data and/or increase the die size (among other effects).

To further reduce the bank cycle time of the memory system 110, the memory system 110 may support additional segmentation (e.g., quarter length segmentation) of the data lines 225 (e.g., at least some segments of data lines 225 may be separated from logic circuitry 210 by repeater circuitry 230). For example, with respect to the system 204, the die 205-c may implement sections 206 similar to those of the die 205-b, where the logic circuitry 210 may be coupled with banks 215 positioned both above and below (in the y direction) the logic circuitry 210. The system 204 may further segment each data line 225 utilizing repeater circuitry 230, such that the data lines 225 (e.g., segments of a data line) may have a length that satisfies a threshold (e.g., a length at which the bank cycle times of the die 205-c satisfy a cycle time threshold), may be coupled with a reduced quantity of banks 215 (e.g., each data line 225 is coupled with a single bank 215, two banks 215, among other examples), or both.

As an illustrative example, the logic circuitry 210-c may be coupled with banks 215-g, 215-h, 215-i, and 215-j that are positioned above (in the y direction) the logic circuitry 210-c, and be coupled with the banks 215-k, 215-m, 215-l, and 215-n that are positioned below (in the y direction) the logic circuitry 210-c. Each bank 215 may also be coupled with bank logic circuitry 220-c. The die 205-c may also include repeater circuitry 230 that may separate, buffer, or be positioned between (in the y direction) the banks 215. For example, the banks 215-g and 215-h may be separated via the repeater circuitry 230-a, while the banks 215-i and 215-j may be separated via repeater circuitry 230. Similarly, the banks 215-k and 215-m may be separated via repeater circuitry 230, while the banks 215-l and 215-n may be separated by repeater circuitry 230. Additionally, as illustrated, the logic circuitry 210 may include repeater circuitry 230, such as the repeater circuitry 230-b, (e.g., a portion of the logic circuitry includes repeater circuitry) to facilitate access to the banks 215.

In this way, by separating (e.g., buffering) the banks 215 using the repeater circuitry 230, the length of the data lines 225 may be further reduced, thereby reducing capacitance of each of the data lines 225 and leading to a decrease in bank cycle times. The repeater circuitry 230 may add to bank cycle times, but that increase may be offset by the decrease in bank cycle times due to the reduction of capacitance of the data lines 225. Thus, each of the banks 215 may be coupled with a respective data line 225 having a reduced length relative to those of the system 200 and the system 202. For example, the banks 215-g, 215-h, 215-i, 215-j, 215-k, 215-m, 215-l, and 215-n may be coupled with the data lines 225-g, 225-h, 225-i, 225-j, 225-k, 225-m, 225-l, and 225-n via respective data path circuitries (e.g., bit lines, sensing circuitry, local I/Os, among other examples), where such data lines 225 may have a reduced capacitance (due to the reduced length), thereby reducing bank cycle times at memory system 110.

As described herein, in addition to buffering the banks 215, the repeater circuitry 230 may include write drivers 235 and read drivers to facilitate communication between the banks 215 and the logic circuitry 210-c. For example, the repeater circuitry may include write drivers 235 to facilitate write operations to the banks 215 from the logic circuitry 210-c to the banks 215 and also include read drivers 240 to facilitate read operations from the banks 215 to the logic circuitry 210-c. To accomplish such communication, the data lines 225 may be toggled (e.g., activated and deactivated) based on which banks 215 are being accessed.

For example, to perform a read operation at the banks 215-g (e.g., banks farther in distance to the logic circuitry 210-c), both data lines 225 may be toggled. As such, in response to a read command, the read driver 240-a of the repeater circuitry 230-a may activate the data line 225-g to receive the data from one of the banks 215-g (via data path circuitry coupling the identified bank 215 with the data line 225-g). In response to the read driver 240-a receiving the data, the read driver 240-b may activate the data line 225-h to receive the data from the read driver 240-a. The read driver 240-a may communicate the data to other portions of the logic circuitry 210-c, such that the logic circuitry 210-c may process the data and output the data to a host device. In this way, by toggling the both the data lines 225, the logic circuitry 210-c may obtain the data read from one of the banks 215-g.

Similarly, to perform a write operation at the banks 215-g, both data lines 225 may be toggled. For example, in response to receiving a write command, the logic circuitry 210-c, via the write driver 235-b of the repeater circuitry 230-b, may activate the data line 225-h to transmit the data to the write driver 235-a of the repeater circuitry 230-a. In response to receiving the data, the write driver 235-a may activate the data line 225-g and write the data to the identified bank 215 of the banks 215-g (via the data path circuitry). In this way, by toggling both of the data lines 225, the logic circuitry 210-c may write data to one of the banks 215-g.

Alternatively, to perform a read operation at the banks 215-h (e.g., banks nearer in distance to the logic circuitry 210-c), the data line 225-h may be activated, while the data line 225-g may be deactivated. For example, in response to a read command, the read driver 240-b of the repeater circuitry 230-b may activate the data line 225-h to receive the data from one of the banks 215-h (via data path circuitry coupling the identified bank 215 with the data line 225-h). In response to the read driver 240-b receiving the data, the read driver 240-b may communicate the data to other portions of the logic circuitry 210-c, such that the logic circuitry 210-c may process the data and output the data to a host device. Accordingly, during such operations, the repeater circuitry 230-a and the data line 225-g may be deactivated, which may reduce power consumption during read operations. In this way, by toggling a single data line 225-h, the logic circuitry 210-c may obtain the data read from one of the banks 215-h.

Similarly, to perform a write operation at the banks 215-h, the data line 225-h may be activated, while the data line 225-g may be deactivated. For example, in response to receiving a write command, the logic circuitry 210-c, via the write driver 235-b of the repeater circuitry 230-b, may activate the data line 225-h to write the data to the identified bank 215 of the banks 215-h (via the data path circuitry). Accordingly, during such operations, the repeater circuitry 230-a and the data line 225-g may be deactivated, which may reduce power consumption during write operations. In this way, by toggling a single data line 225-h, the logic circuitry 210-c may write data to one of the banks 215-h.

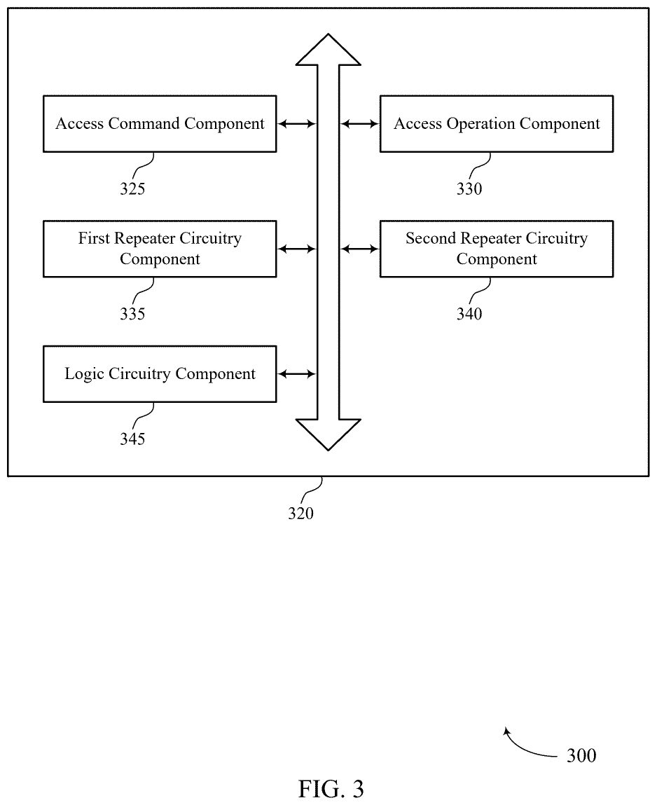

FIG. 3 shows a block diagram 300 of a memory system 320 that supports segmented data lines in memory systems in accordance with examples as disclosed herein. The memory system 320 may be an example of aspects of a memory system as described with reference to FIGS. 1 through 2. The memory system 320, or various components thereof, may be an example of means for performing various aspects of segmented data lines in memory systems as described herein. For example, the memory system 320 may include an access command component 325, an access operation component 330, a first repeater circuitry component 335, a second repeater circuitry component 340, a logic circuitry component 345, or any combination thereof. Each of these components, or components of subcomponents thereof (e.g., one or more processors, one or more memories), may communicate, directly or indirectly, with one another (e.g., via one or more buses).

The memory system 320 may support operating a memory system in accordance with examples as disclosed herein. The access command component 325 may be configured as or otherwise support a means for receiving an access command directed to a first bank of a plurality of banks at the memory system. The access operation component 330 may be configured as or otherwise support a means for performing an access operation at the first bank in response to receiving the access command. The first repeater circuitry component 335 may be configured as or otherwise support a means for activating, by first repeater circuitry, a second segment of a data line that is coupled with the first bank. The second repeater circuitry component 340 may be configured as or otherwise support a means for activating, by second repeater circuitry, a first segment of the data line that is coupled with other banks of the plurality of banks.

In some examples, the access command includes a read command and, to support performing the access operation, the first repeater circuitry component 335 may be configured as or otherwise support a means for reading data from the first bank in accordance with activating the second segment of the data line. In some examples, the access command includes a read command and, to support performing the access operation, the second repeater circuitry component 340 may be configured as or otherwise support a means for communicating the data between the first repeater circuitry and logic circuitry of the memory system via the first segment of the data line in accordance with activating the first segment of the data line.

In some examples, the access command includes a write command and, to support performing the access operation, the logic circuitry component 345 may be configured as or otherwise support a means for obtaining, at the second repeater circuitry, data from logic circuitry coupled with one or more controllers of the memory system. In some examples, the access command includes a write command and, to support performing the access operation, the second repeater circuitry component 340 may be configured as or otherwise support a means for communicating the data from the second repeater circuitry to the first repeater circuitry via the first segment of the data line in accordance with activating the first segment of the data line. In some examples, the access command includes a write command and, to support performing the access operation, the first repeater circuitry component 335 may be configured as or otherwise support a means for writing the data to the first bank via the second segment of the data line in accordance with activating the second segment of the data line.

In some examples, the access command component 325 may be configured as or otherwise support a means for receiving a second access command directed a second bank. In some examples, the access operation component 330 may be configured as or otherwise support a means for performing a second access operation at the second bank in response to receiving the second access command. In some examples, the second repeater circuitry component 340 may be configured as or otherwise support a means for activating, by the second repeater circuitry, the first segment of the data line. In some examples, the first repeater circuitry component 335 may be configured as or otherwise support a means for refraining, by the first repeater circuitry, from activating the second segment of the data line, where the second bank is coupled with the first segment of the data line.

In some examples, the first segment of the data line is coupled with two or more first banks of the plurality of banks. In some examples, the second segment of the data line is coupled with two or more second banks of the plurality of banks.

In some examples, the first segment of the data line is coupled with a first single bank of the plurality of banks. In some examples, the second segment of the data line is coupled with a second single bank of the plurality of banks.

In some examples, a length of the first segment of the data line and a length of the second segment of the data line both satisfy a distance threshold.

In some examples, a length of the first segment of the data line is equivalent to a length of the second segment of the data line.

In some examples, a length of the first segment of the data line is different from a length of the second segment of the data line.

In some examples, the first repeater circuitry is positioned between a first set of the plurality of banks including the first bank and the other banks.

Additionally, or alternatively, the memory system 320 may support operating a memory system in accordance with examples as disclosed herein. In some examples, the access command component 325 may be configured as or otherwise support a means for receiving an access command directed to a first bank of a plurality of banks at the memory system. In some examples, the access operation component 330 may be configured as or otherwise support a means for performing an access operation at the first bank in response to receiving the access command. In some examples, the first repeater circuitry component 335 may be configured as or otherwise support a means for activating, by first repeater circuitry, a first segment of a data line. In some examples, the second repeater circuitry component 340 may be configured as or otherwise support a means for refraining, by a second repeater circuitry, from activating a second segment of the data line, where a second bank is coupled with the second segment of the data line.

In some examples, the first segment of the data line is coupled with two or more first banks of the plurality of banks. In some examples, the second segment of the data line is coupled with two or more second banks of the plurality of banks.

In some examples, the first segment of the data line is coupled with a first single bank of the plurality of banks. In some examples, the second segment of the data line is coupled with a second single bank of the plurality of banks.

In some examples, a length of the first segment of the data line and a length of the second segment of the data line both satisfy a distance threshold.

In some examples, a length of the first segment of the data line is equivalent to a length of the second segment of the data line.

In some examples, a length of the first segment of the data line is different from a length of the second segment of the data line.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

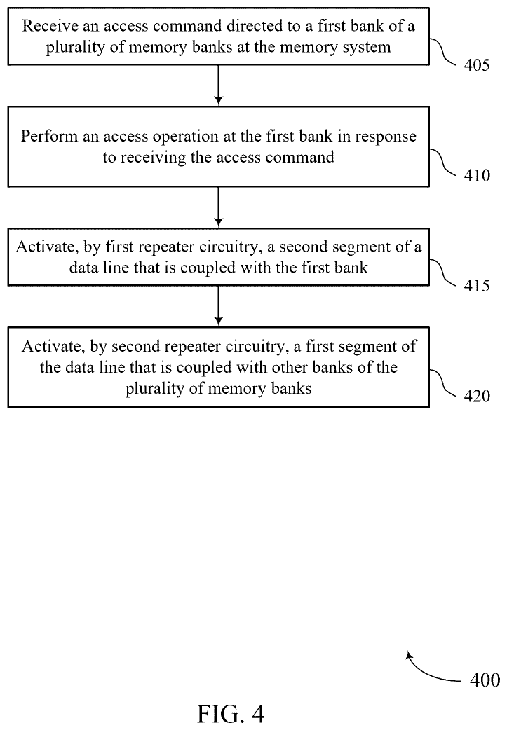

FIG. 4 shows a flowchart illustrating a method 400 that supports segmented data lines in memory systems in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving an access command (e.g., read or write command) directed to a first bank of a plurality of banks (e.g., banks 215-g, 215-i, 215-m, or 215-n) at the memory system. In some examples, aspects of the operations of 405 may be performed by an access command component 325 as described with reference to FIG. 3.

At 410, the method may include performing an access operation (e.g., read or write operations, as described in FIG. 2C) at the first bank in response to receiving the access command. In some examples, aspects of the operations of 410 may be performed by an access operation component 330 as described with reference to FIG. 3.

At 415, the method may include activating, by first repeater circuitry (e.g., repeater circuitry 230-a), a second segment of a data line (e.g., 225-g) that is coupled with the first bank. In some examples, aspects of the operations of 415 may be performed by a first repeater circuitry component 335 as described with reference to FIG. 3.

At 420, the method may include activating, by second repeater circuitry (e.g., repeater circuitry 230-b), a first segment of the data line (e.g., repeater circuitry 230-b) that is coupled with other banks of the plurality of banks (e.g., banks 215-h, 215-j, 215-k, or 215-l). In some examples, aspects of the operations of 420 may be performed by a second repeater circuitry component 340 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving an access command directed to a first bank of a plurality of banks at the memory system; performing an access operation at the first bank in response to receiving the access command, where performing the access operation includes; activating, by first repeater circuitry, a second segment of a data line that is coupled with the first bank; and activating, by second repeater circuitry, a first segment of the data line that is coupled with other banks of the plurality of banks.

Aspect 2: The method, apparatus, or non-transitory computer-readable medium of aspect 1, where the access command includes a read command, and performing the access operation includes operations, features, circuitry, logic, means, or instructions, or any combination thereof for reading data from the first bank in accordance with activating the second segment of the data line and communicating the data between the first repeater circuitry and logic circuitry of the memory system via the first segment of the data line in accordance with activating the first segment of the data line.

Aspect 3: The method, apparatus, or non-transitory computer-readable medium of any of aspects 1 through 2, where the access command includes a write command, and performing the access operation includes operations, features, circuitry, logic, means, or instructions, or any combination thereof for obtaining, at the second repeater circuitry, data from logic circuitry coupled with one or more controllers of the memory system; communicating the data from the second repeater circuitry to the first repeater circuitry via the first segment of the data line in accordance with activating the first segment of the data line; and writing the data to the first bank via the second segment of the data line in accordance with activating the second segment of the data line.

Aspect 4: The method, apparatus, or non-transitory computer-readable medium of any of aspects 1 through 3, further including operations, features, circuitry, logic, means, or instructions, or any combination thereof for receiving a second access command directed a second bank; performing a second access operation at the second bank in response to receiving the second access command, where performing the second access command includes; activating, by the second repeater circuitry, the first segment of the data line; and refraining, by the first repeater circuitry, from activating the second segment of the data line, where the second bank is coupled with the first segment of the data line.

Aspect 5: The method, apparatus, or non-transitory computer-readable medium of any of aspects 1 through 4, where the first segment of the data line is coupled with two or more first banks of the plurality of banks and the second segment of the data line is coupled with two or more second banks of the plurality of banks.

Aspect 6: The method, apparatus, or non-transitory computer-readable medium of any of aspects 1 through 5, where the first segment of the data line is coupled with a first single bank of the plurality of banks and the second segment of the data line is coupled with a second single bank of the plurality of banks.

Aspect 7: The method, apparatus, or non-transitory computer-readable medium of any of aspects 1 through 6, where a length of the first segment of the data line and a length of the second segment of the data line both satisfy a distance threshold.

Aspect 8: The method, apparatus, or non-transitory computer-readable medium of any of aspects 1 through 7, where a length of the first segment of the data line is equivalent to a length of the second segment of the data line.

Aspect 9: The method, apparatus, or non-transitory computer-readable medium of any of aspects 1 through 8, where a length of the first segment of the data line is different from a length of the second segment of the data line.

Aspect 10: The method, apparatus, or non-transitory computer-readable medium of any of aspects 1 through 9, where the first repeater circuitry is positioned between a first set of the plurality of banks including the first bank and the other banks.

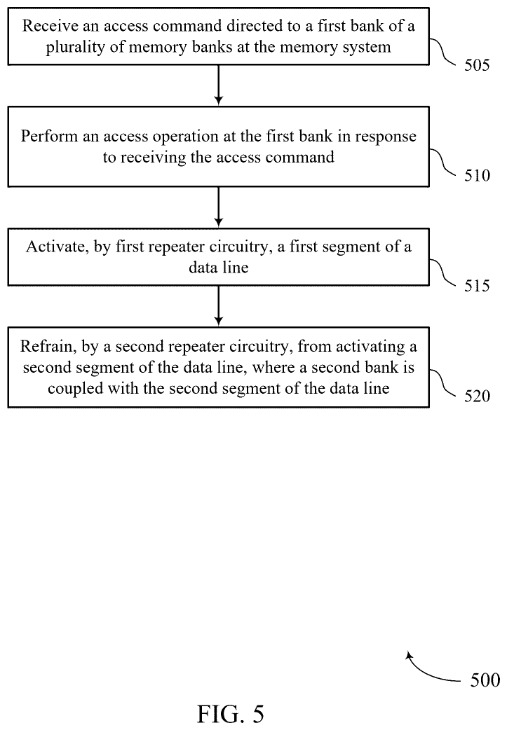

FIG. 5 shows a flowchart illustrating a method 500 that supports segmented data lines in memory systems in accordance with examples as disclosed herein. The operations of method 500 may be implemented by a memory system or its components as described herein. For example, the operations of method 500 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 505, the method may include receiving an access command (e.g., read or write command) directed to a first bank (e.g., bank 215) of a plurality of banks (e.g., banks 215-h, 215-j, 215-k, or 215-l) at the memory system. In some examples, aspects of the operations of 505 may be performed by an access command component 325 as described with reference to FIG. 3.

At 510, the method may include performing an access operation (e.g., read or write operation, as described herein with reference to FIG. 2C) at the first bank (e.g., bank 215) in response to receiving the access command. In some examples, aspects of the operations of 510 may be performed by an access operation component 330 as described with reference to FIG. 3.

At 515, the method may include activating, by first repeater circuitry (e.g., repeater circuitry 230-b), a first segment of a data line (e.g., data line 225-h). In some examples, aspects of the operations of 515 may be performed by a first repeater circuitry component 335 as described with reference to FIG. 3.

At 520, the method may include refraining, by a second repeater circuitry (e.g., repeater circuitry 230-a), from activating a second segment of the data line (e.g., data line 225-h), where a second bank is coupled with the second segment of the data line. In some examples, aspects of the operations of 520 may be performed by a second repeater circuitry component 340 as described with reference to FIG. 3.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for receiving an access command directed to a first bank of a plurality of banks at the memory system; performing an access operation at the first bank in response to receiving the access command, where performing the access operation includes; activating, by first repeater circuitry, a first segment of a data line; and refraining, by a second repeater circuitry, from activating a second segment of the data line, where a second bank is coupled with the second segment of the data line.

Aspect 12: The method, apparatus, or non-transitory computer-readable medium of aspect 11, where the first segment of the data line is coupled with two or more first banks of the plurality of banks and the second segment of the data line is coupled with two or more second banks of the plurality of banks.

Aspect 13: The method, apparatus, or non-transitory computer-readable medium of any of aspects 11 through 12, where the first segment of the data line is coupled with a first single bank of the plurality of banks and the second segment of the data line is coupled with a second single bank of the plurality of banks.

Aspect 14: The method, apparatus, or non-transitory computer-readable medium of any of aspects 11 through 13, where a length of the first segment of the data line and a length of the second segment of the data line both satisfy a distance threshold.

Aspect 15: The method, apparatus, or non-transitory computer-readable medium of any of aspects 11 through 14, where a length of the first segment of the data line is equivalent to a length of the second segment of the data line.

Aspect 16: The method, apparatus, or non-transitory computer-readable medium of any of aspects 11 through 15, where a length of the first segment of the data line is different from a length of the second segment of the data line.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 17: A memory system, including: a first plurality of banks and a second plurality of banks; logic circuitry coupled with the first plurality of banks and the second plurality of banks and configured to facilitate communication with the first plurality of banks and the second plurality of banks, the logic circuitry positioned between the first plurality of banks and the second plurality of banks; a first segment of a data line coupled with a first set of the first plurality of banks and coupled with the logic circuitry; a second segment of the data line coupled with a second set of the first plurality of banks; and repeater circuitry coupled with the first segment and the second segment and positioned between the first set of the first plurality of banks and the second set of the first plurality of banks.

Aspect 18: The memory system of aspect 17, where the repeater circuitry includes a read driver configured to: read data from the second set of the first plurality of banks via the second segment of the data line in accordance with activating the second segment of the data line; and communicate the data to the logic circuitry via the first segment of the data line in accordance with activating the first segment of the data line.

Aspect 19: The memory system of any of aspects 17 through 18, where the repeater circuitry includes a write driver configured to: obtain data from the logic circuitry via the first segment of the data line in accordance with activating the first segment of the data line; and write the data to the second set of the first plurality of banks via the second segment of the data line in accordance with activating the second segment of the data line.

Aspect 20: The memory system of any of aspects 17 through 19, where: a first portion of the logic circuitry includes second repeater circuitry, and a second portion of the logic circuitry includes column select circuitry, column decoder circuitry, I/O circuitry, a through silicon via, or any combination thereof.

Aspect 21: The memory system of aspect 20, where the first segment of the data line is coupled with the second portion of the logic circuitry via the second repeater circuitry.

Aspect 22: The memory system of any of aspects 20 through 21, where the second repeater circuitry includes a read driver configured to: read data from the first set of the first plurality of banks via the first segment of the data line in accordance with activating the first segment of the data line; and communicate the data to the logic circuitry in accordance with reading the data from the first set of the first plurality of banks.

Aspect 23: The memory system of any of aspects 20 through 22, where the second repeater circuitry includes a write driver configured to: obtain data from the logic circuitry in response to a write command directed to the first set of the first plurality of banks; and write the data to the first set of the first plurality of banks via the first segment of the data line in accordance with activating the first segment of the data line.

Aspect 24: The memory system of any of aspects 17 through 23, where the first segment of the data line is coupled with two or more first banks of the first plurality of banks, and the second segment of the data line is coupled with two or more second banks of the first plurality of banks.

Aspect 25: The memory system of any of aspects 17 through 24, where the first segment of the data line is coupled with a first single bank of the first plurality of banks, and the second segment of the data line is coupled with a second single bank of the first plurality of banks.

Aspect 26: The memory system of any of aspects 17 through 25, where a length of the first segment of the data line and a length of the second segment of the data line both satisfy a distance threshold.

Aspect 27: The memory system of any of aspects 17 through 26, where a length of the first segment of the data line is equivalent to a length of the second segment of the data line.

Aspect 28: The memory system of any of aspects 17 through 27, where a length of the first segment of the data line is different from a length of the second segment of the data line.

An apparatus is described. The following provides an overview of aspects of the apparatus as described herein:

Aspect 29: A memory system, including: one or more memory devices; and one or more controllers coupled with the one or more memory devices and configured to cause the memory system to: receive an access command directed to a first bank of a plurality of banks at the memory system; and perform an access operation at the first bank in response to receiving the access command, where performing the access operation includes: activate, by first repeater circuitry, a second segment of a data line that is coupled with the first bank; and activate, by second repeater circuitry, a first segment of the data line that is coupled with other banks of the plurality of banks.

Aspect 30: The memory system of aspect 29, where the access command includes a read command, and, to perform the access operation, the one or more controllers are configured to cause the memory system to: read data from the first bank in accordance with activating the second segment of the data line; and communicate the data between the first repeater circuitry and logic circuitry of the memory system via the first segment of the data line in accordance with activating the first segment of the data line.

Aspect 31: The memory system of any of aspects 29 through 30, where the access command includes a write command, and, to perform the access operation, the one or more controllers are configured to cause the memory system to: obtain, at the second repeater circuitry, data from logic circuitry coupled with one or more controllers of the memory system; communicate the data from the second repeater circuitry to the first repeater circuitry via the first segment of the data line in accordance with activating the first segment of the data line; and write the data to the first bank via the second segment of the data line in accordance with activating the second segment of the data line.

Aspect 32: The memory system of any of aspects 29 through 31, where the one or more controllers are configured to cause the memory system to: receive a second access command directed a second bank; and perform a second access operation at the second bank in response to receiving the second access command, where performing the second access command includes: activate, by the second repeater circuitry, the first segment of the data line; and refrain, by the first repeater circuitry, from activating the second segment of the data line, where the second bank is coupled with the first segment of the data line.

Aspect 33: The memory system of any of aspects 29 through 32, where: the first segment of the data line is coupled with two or more first banks of the plurality of banks, and the second segment of the data line is coupled with two or more second banks of the plurality of banks.

Aspect 34: The memory system of any of aspects 29 through 33, where: the first segment of the data line is coupled with a first single bank of the plurality of banks, and the second segment of the data line is coupled with a second single bank of the plurality of banks.

Aspect 35: The memory system of any of aspects 29 through 34, where a length of the first segment of the data line and a length of the second segment of the data line both satisfy a distance threshold.

Aspect 36: The memory system of any of aspects 29 through 35, where a length of the first segment of the data line is equivalent to a length of the second segment of the data line.

Aspect 37: The memory system of any of aspects 29 through 36, where a length of the first segment of the data line is different from a length of the second segment of the data line.

Aspect 38: The memory system of any of aspects 29 through 37, where the first repeater circuitry is positioned between a first set of the plurality of banks including the first bank and the other banks.

An apparatus is described. The following provides an overview of aspects of the apparatus as described herein:

Aspect 39: A memory system, including: one or more memory devices; and one or more controllers coupled with the one or more memory devices and configured to cause the memory system to: receive an access command directed to a first bank of a plurality of banks at the memory system; and perform an access operation at the first bank in response to receiving the access command, where performing the access operation includes: activate, by first repeater circuitry, a first segment of a data line; and refrain, by a second repeater circuitry, from activating a second segment of the data line, where a second bank is coupled with the second segment of the data line.

Aspect 40: The memory system of aspect 39, where: the first segment of the data line is coupled with two or more first banks of the plurality of banks, and the second segment of the data line is coupled with two or more second banks of the plurality of banks.

Aspect 41: The memory system of any of aspects 39 through 40, where: the first segment of the data line is coupled with a first single bank of the plurality of banks, and the second segment of the data line is coupled with a second single bank of the plurality of banks.

Aspect 42: The memory system of any of aspects 39 through 41, where a length of the first segment of the data line and a length of the second segment of the data line both satisfy a distance threshold.

Aspect 43: The memory system of any of aspects 39 through 42, where a length of the first segment of the data line is equivalent to a length of the second segment of the data line.

Aspect 44: The memory system of any of aspects 39 through 43, where a length of the first segment of the data line is different from a length of the second segment of the data line.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “isolated” may refer to a relationship between components in which signals are not presently capable of flowing between the components. Components are isolated from each other if there is an open circuit between them. For example, two components separated by a switch that is positioned between the components are isolated from each other when the switch is open. When a component isolates two components, the component may initiate a change that prevents signals from flowing between the other components using a conductive path that previously permitted signals to flow.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
a first plurality of banks and a second plurality of banks;
logic circuitry coupled with the first plurality of banks and the second plurality of banks and configured to facilitate communication with the first plurality of banks and the second plurality of banks, the logic circuitry positioned between the first plurality of banks and the second plurality of banks;
a first segment of a data line coupled with a first set of the first plurality of banks and coupled with the logic circuitry;
a second segment of the data line coupled with a second set of the first plurality of banks; and
repeater circuitry coupled with the first segment and the second segment and positioned between the first set of the first plurality of banks and the second set of the first plurality of banks.

2. The memory system of claim 1, wherein the repeater circuitry comprises a read driver configured to:
read data from the second set of the first plurality of banks via the second segment of the data line in accordance with activating the second segment of the data line; and
communicate the data to the logic circuitry via the first segment of the data line in accordance with activating the first segment of the data line.

3. The memory system of claim 1, wherein the repeater circuitry comprises a write driver configured to:
obtain data from the logic circuitry via the first segment of the data line in accordance with activating the first segment of the data line; and
write the data to the second set of the first plurality of banks via the second segment of the data line in accordance with activating the second segment of the data line.

4. The memory system of claim 1, wherein:
a first portion of the logic circuitry comprises second repeater circuitry, and
a second portion of the logic circuitry comprises column select circuitry, column decoder circuitry, input/output (I/O) circuitry, a through silicon via, or any combination thereof.

5. The memory system of claim 4, wherein the first segment of the data line is coupled with the second portion of the logic circuitry via the second repeater circuitry.

6. The memory system of claim 4, wherein the second repeater circuitry comprises a read driver configured to:
read data from the first set of the first plurality of banks via the first segment of the data line in accordance with activating the first segment of the data line; and
communicate the data to the logic circuitry in accordance with reading the data from the first set of the first plurality of banks.

7. The memory system of claim 4, wherein the second repeater circuitry comprises a write driver configured to:
obtain data from the logic circuitry in response to a write command directed to the first set of the first plurality of banks; and
write the data to the first set of the first plurality of banks via the first segment of the data line in accordance with activating the first segment of the data line.

8. The memory system of claim 1, wherein the first segment of the data line is coupled with two or more first banks of the first plurality of banks, and the second segment of the data line is coupled with two or more second banks of the first plurality of banks.

9. The memory system of claim 1, wherein the first segment of the data line is coupled with a first single bank of the first plurality of banks, and the second segment of the data line is coupled with a second single bank of the first plurality of banks.

10. The memory system of claim 1, wherein a length of the first segment of the data line and a length of the second segment of the data line both satisfy a distance threshold.

11. The memory system of claim 1, wherein a length of the first segment of the data line is equivalent to a length of the second segment of the data line.

12. The memory system of claim 1, wherein a length of the first segment of the data line is different from a length of the second segment of the data line.

13. A memory system, comprising:
one or more memory devices; and
one or more controllers coupled with the one or more memory devices and configured to cause the memory system to:
receive an access command directed to a first bank of a plurality of banks at the memory system; and
perform an access operation at the first bank in response to receiving the access command, wherein performing the access operation comprises:
activate, by first repeater circuitry, a second segment of a data line that is coupled with the first bank; and
activate, by second repeater circuitry, a first segment of the data line that is coupled with other banks of the plurality of banks.

14. The memory system of claim 13, wherein the access command comprises a read command, and, to perform the access operation, the one or more controllers are configured to cause the memory system to:
read data from the first bank in accordance with activating the second segment of the data line; and
communicate the data between the first repeater circuitry and logic circuitry of the memory system via the first segment of the data line in accordance with activating the first segment of the data line.

15. The memory system of claim 13, wherein the access command comprises a write command, and, to perform the access operation, the one or more controllers are configured to cause the memory system to:
obtain, at the second repeater circuitry, data from logic circuitry coupled with the one or more controllers of the memory system;
communicate the data from the second repeater circuitry to the first repeater circuitry via the first segment of the data line in accordance with activating the first segment of the data line; and
write the data to the first bank via the second segment of the data line in accordance with activating the second segment of the data line.

16. The memory system of claim 13, wherein the one or more controllers are configured to cause the memory system to:
receive a second access command directed a second bank; and
perform a second access operation at the second bank in response to receiving the second access command, wherein performing the second access command comprises:
activate, by the second repeater circuitry, the first segment of the data line; and
refrain, by the first repeater circuitry, from activating the second segment of the data line, wherein the second bank is coupled with the first segment of the data line.

17. The memory system of claim 13, wherein:
the first segment of the data line is coupled with two or more first banks of the plurality of banks, and
the second segment of the data line is coupled with two or more second banks of the plurality of banks.

18. The memory system of claim 13, wherein:
the first segment of the data line is coupled with a first single bank of the plurality of banks, and
the second segment of the data line is coupled with a second single bank of the plurality of banks.

19. The memory system of claim 13, wherein a length of the first segment of the data line and a length of the second segment of the data line both satisfy a distance threshold.

20. The memory system of claim 13, wherein a length of the first segment of the data line is equivalent to a length of the second segment of the data line.

21. The memory system of claim 13, wherein a length of the first segment of the data line is different from a length of the second segment of the data line.

22. The memory system of claim 13, wherein the first repeater circuitry is positioned between a first set of the plurality of banks including the first bank and the other banks.

23. A memory system, comprising:
one or more memory devices; and
one or more controllers coupled with the one or more memory devices and configured to cause the memory system to:
receive an access command directed to a first bank of a plurality of banks at the memory system; and
perform an access operation at the first bank in response to receiving the access command, wherein performing the access operation comprises:
activate, by first repeater circuitry, a first segment of a data line; and
refrain, by a second repeater circuitry, from activating a second segment of the data line, wherein a second bank is coupled with the second segment of the data line.

24. The memory system of claim 23, wherein:
the first segment of the data line is coupled with two or more first banks of the plurality of banks, and
the second segment of the data line is coupled with two or more second banks of the plurality of banks.

25. The memory system of claim 23, wherein:
the first segment of the data line is coupled with a first single bank of the plurality of banks, and
the second segment of the data line is coupled with a second single bank of the plurality of banks.

26. The memory system of claim 23, wherein a length of the first segment of the data line and a length of the second segment of the data line both satisfy a distance threshold.

27. The memory system of claim 23, wherein a length of the first segment of the data line is equivalent to a length of the second segment of the data line.

28. The memory system of claim 23, wherein a length of the first segment of the data line is different from a length of the second segment of the data line.

29. A method for operating a memory system, comprising:
receiving an access command directed to a first bank of a plurality of banks at the memory system; and
performing an access operation at the first bank in response to receiving the access command, wherein performing the access operation comprises:
activating, by first repeater circuitry, a second segment of a data line that is coupled with the first bank; and
activating, by second repeater circuitry, a first segment of the data line that is coupled with other banks of the plurality of banks.

30. A method for operating a memory system, comprising:
receiving an access command directed to a first bank of a plurality of banks at the memory system; and
performing an access operation at the first bank in response to receiving the access command, wherein performing the access operation comprises:
activating, by first repeater circuitry, a first segment of a data line; and
refraining, by a second repeater circuitry, from activating a second segment of the data line, wherein a second bank is coupled with the second segment of the data line.
